(19) United States
(12) Patent Application Publication
(10) Pub. No.: US 2023/0141006 A1
(43) Pub. Date: May 11, 2023

(54) CONTROL DEVICE, VEHICLE, MOBILE TERMINAL, AND DISPLAY DEVICE

(71) Applicant: TOYOTA JIDOSHA KABUSHIKI KAISHA, Toyota-shi (JP)

(72) Inventors: Sui KURIHASHI, Sunto-gun (JP); Yuki TAKAHASHI, Susono-shi (JP)

(73) Assignee: TOYOTA JIDOSHA KABUSHIKI KAISHA, Toyota-shi (JP)

(21) Appl. No.: 17/944,689

(22) Filed: Sep. 14, 2022

(30) Foreign Application Priority Data
Nov. 10, 2021 (JP) 2021-183693

(51) Int. Cl. B60W 50/14; B60W 20/12; B60W 30/16; B60W 50/00

(52) U.S. Cl. CPC B60W 50/14; B60W 20/12; B60W 30/16; B60W 50/0097; B60W 2050/146

(57) ABSTRACT

A control device of a display device that displays a traveling position of a predetermined vehicle relative to a preceding vehicle in platoon traveling, includes: a detector that detects a candidate preceding vehicle to follow from among one or more vehicles traveling around the predetermined vehicle; a calculator that calculates, with respect to the detected candidate preceding vehicle, a reduction effect of energy consumption obtained by the predetermined vehicle when the predetermined vehicle travels following the candidate preceding vehicle; and a controller that executes display control to display, on the display device, a recommended travel area based on the reduction effect of energy consumption as an area in which the predetermined vehicle is recommended to travel. Further, the recommended travel area is an area indicating a predetermined inter-vehicle distance behind the candidate preceding vehicle.

### CROSS-REFERENCE TO RELATED APPLICATION(S)

The present application claims priority to and incorporates by reference the entire contents of Japanese Patent Application No. 2021-183693 filed in Japan on Nov. 10, 2021.

### BACKGROUND

The present disclosure relates to a control device, a display device, a vehicle, and a mobile terminal.

When a plurality of vehicles travels in a platoon, Japanese Laid-open Patent Publication No. 2020-194566 discloses formation of the platoon in a first vehicle order of arranging vehicles in an order of longer braking distance from a head to tail of the platoon or a second vehicle order of arranging a vehicle with the largest air resistance at the head of the platoon.

### SUMMARY

There is a need for providing a control device, a vehicle, a mobile terminal, and a display device capable of visually notifying a driver of a traveling position that can reduce energy consumption of a predetermined vehicle in platoon traveling.

According to an embodiment, a control device of a display device that displays a traveling position of a predetermined vehicle relative to a preceding vehicle in platoon traveling, includes: a detector that detects a candidate preceding vehicle to follow from among one or more vehicles traveling around the predetermined vehicle; a calculator that calculates, with respect to the detected candidate preceding vehicle, a reduction effect of energy consumption obtained by the predetermined vehicle when the predetermined vehicle travels following the candidate preceding vehicle; and a controller that executes display control to display, on the display device, a recommended travel area based on the reduction effect of energy consumption as an area in which the predetermined vehicle is recommended to travel. Further, the recommended travel area is an area indicating a predetermined inter-vehicle distance behind the candidate preceding vehicle.

According to an embodiment, a display device that displays a traveling position of a predetermined vehicle relative to a preceding vehicle in platoon traveling, displays a recommended travel area based on a reduction effect of energy consumption obtained by the predetermined vehicle when the predetermined vehicle travels following a candidate preceding vehicle detected as a vehicle to follow from among one or more vehicles traveling around the predetermined vehicle. Further, the recommended travel area is an area where the predetermined vehicle is recommended to travel and that indicates a predetermined inter-vehicle distance behind the candidate preceding vehicle.

### BRIEF DESCRIPTION OF THE DRAWINGS

FIG. 1 is a diagram illustrating a recommended travel area in platoon traveling;

FIG. 2 is a block diagram schematically illustrating a vehicle according to the first embodiment;

FIG. 3 is a flowchart illustrating a display control flow;

FIG. 4 is a block diagram illustrating a configuration of a second embodiment;

FIG. 5 is a flowchart illustrating a control flow on a vehicle side in the second embodiment;

FIG. 6 is a flowchart illustrating a control flow on a mobile terminal side in the second embodiment; and

FIG. 7 is a block diagram illustrating a configuration of a third embodiment.

### DETAILED DESCRIPTION

In a configuration described in Japanese Laid-open Patent Publication No. 2020-194566, although energy consumption can be reduced in the entire platoon, a distance to a preceding vehicle is important, in addition to the order of the platoon, for effectively reducing the energy consumption. In a case where the distance to the preceding vehicle is not appropriate in platoon traveling, an effect of improving fuel efficiency and electric efficiency will be reduced, and furthermore, there is a possibility that the distance to the preceding vehicle may be too short.

Hereinafter, a control device, a display device, a vehicle, and a mobile terminal according to embodiments of the present disclosure will be specifically described with reference to the drawings. Note that the present disclosure is not limited to the embodiments described below.

### First Embodiment

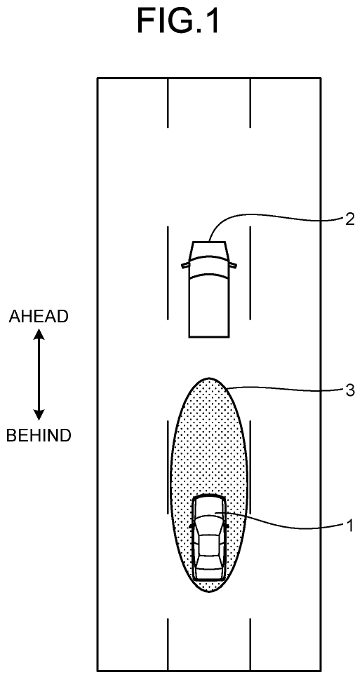

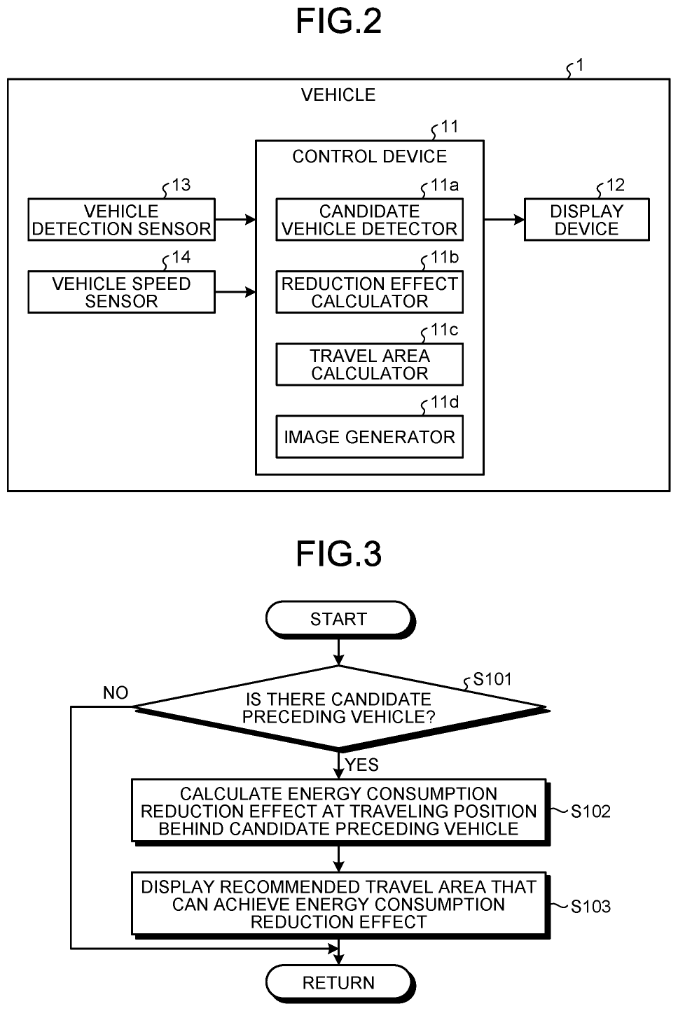

FIG. 1 is a diagram illustrating a recommended travel area in platoon traveling. FIG. 2 is a block diagram schematically illustrating a vehicle according to the first embodiment.

In the first embodiment, as illustrated in FIG. 1, when a vehicle 1 travels at a rear position of a preceding vehicle 2 in platoon traveling, an area that the vehicle 1 is recommended to travel (hereinafter referred to as a recommended travel area) 3 can be visualized. The vehicle 1 is equipped with a system (automatic following system) to travel following the preceding vehicle 2 that is traveling ahead of the vehicle 1, such as radar cruise control, automatic cruise control, or adaptive cruise control.

The vehicle 1 is a battery electric vehicle equipped with a motor as a driving power source. In the vehicle 1, the motor is driven by supplying electric power stored in a battery to the motor, and power output from the motor is transmitted to a drive wheel via a power transmission device. Since the vehicle 1 travels by the power obtained by consuming the electric power, an electric efficiency increases and a cruising distance can be extended in a travel state with good energy efficiency. Note that, in the description, the vehicle 1 may be referred to as an “own vehicle”.

As illustrated in FIG. 2, the vehicle 1 includes a control device 11 and a display device 12.

The control device 11 is configured with an electronic control device that controls the vehicle 1. The electronic control device is configured to include a microcomputer equipped with a CPU, a RAM, a ROM, and an input/output interface. The control device 11 performs signal processing according to a program stored in advance in the ROM. Signals from various sensors installed in the vehicle 1 are input to the control device 11. The vehicle 1 is equipped with a vehicle detection sensor 13 and a vehicle speed sensor 14 as in-vehicle sensors.

The vehicle detection sensor 13 is a sensor that detects the preceding vehicle 2. The vehicle detection sensor 13 is configured with, for example, a front camera and a millimeter wave radar. In the first embodiment, the vehicle detection sensor 13 is configured to include the front camera and the millimeter wave radar. Therefore, the vehicle detection sensor 13 outputs preceding vehicle information including an image of the front camera and a measurement result of the millimeter wave radar to the control device 11. The preceding vehicle 2 described here includes a vehicle traveling ahead of the vehicle 1, a vehicle traveling around the vehicle 1, and a candidate preceding vehicle to follow. In other words, the vehicle detection sensor 13 is a sensor that detects vehicles traveling around the own vehicle, and is a sensor for detecting a vehicle to follow by the own vehicle.

The vehicle speed sensor 14 detects a vehicle speed of the vehicle 1 from a pulse signal corresponding to a rotation speed of an axle.

Signals output from the vehicle detection sensor 13 and the vehicle speed sensor 14 are input to the control device 11. In the control device 11, display control of displaying a recommended travel area 3 in the platoon traveling is executed based on signals input from the vehicle detection sensor 13 and the vehicle speed sensor 14. In other words, the control device 11 is configured to include a controller that executes the display control of the recommended travel area 3. When executing the display control, the control device 11 sets the recommended travel area 3 based on an energy consumption reduction effect in the platoon traveling, and displays the recommended travel area 3 on the display device 12.

More specifically, the control device 11 includes a candidate vehicle detector 11a, a reduction effect calculator 11b, a travel area calculator 11c, and an image generator 11d.

The candidate vehicle detector 11a detects the candidate preceding vehicle as a vehicle to follow in vehicles traveling around the vehicle 1. The candidate vehicle detector 11a uses the preceding vehicle information input from the vehicle detection sensor 13 to detect a vehicle that will be a candidate for a vehicle to follow by the own vehicle in the platoon traveling. Since the preceding vehicle information includes an image ahead of the own vehicle and the measurement result by the radar, the candidate vehicle detector 11a can detect the preceding vehicle 2 to follow based on the image ahead of the own vehicle and the measurement result of the millimeter wave radar.

The reduction effect calculator 11b calculates the energy consumption reduction effect achievable by the vehicle 1 when the vehicle 1 follows the candidate preceding vehicle. The reduction effect calculator 11b calculates the energy consumption reduction effect with respect to the candidate vehicle detected by the candidate vehicle detector 11a. In addition, since the vehicle 1 in the first embodiment is a battery electric vehicle, the reduction effect calculator 11b calculates an effect of reducing power consumed during a following travel. In other words, the reduction effect calculator 11b calculates a power consumption reduction effect.

In addition, the reduction effect calculator 11b calculates, for example, an air resistance reduction effect by the following travel as the energy consumption reduction effect. The air resistance received by the vehicle 1 during traveling is obtained by a product of multiplication of a front projected area of the vehicle 1, an air resistance coefficient, and a pressure. Still more, the air resistance reduction effect achievable by the following travel can be calculated based on a physical size of the candidate preceding vehicle, a distance between the own vehicle and the candidate preceding vehicle (inter-vehicle distance), and the vehicle speed. In this case, the physical size of the candidate preceding vehicle and the inter-vehicle distance to the candidate preceding vehicle can be calculated based on the preceding vehicle information acquired by the vehicle detection sensor 13. For example, the reduction effect calculator 11b analyzes the image ahead of the own vehicle acquired by the front camera included in the vehicle detection sensor 13 to calculate the physical size of the candidate preceding vehicle, and also calculates the inter-vehicle distance between the own vehicle and the candidate preceding vehicle. Alternatively, the reduction effect calculator 11b calculates the inter-vehicle distance between the candidate preceding vehicle and the own vehicle based on a radar measurement result acquired by the millimeter wave radar included in the vehicle detection sensor 13. The vehicle speed can be detected by the vehicle speed sensor 14. Then, the reduction effect calculator 11b calculates the air resistance reduction effect based on the physical size of the candidate preceding vehicle, the inter-vehicle distance, and the vehicle speed. As an example, when the inter-vehicle distance between the candidate preceding vehicle and the own vehicle is short, the air resistance reduction effect increases. When the inter-vehicle distance between the candidate preceding vehicle and the own vehicle is long, the air resistance reduction effect decreases.

The travel area calculator 11c calculates the recommended travel area 3 according to the energy consumption reduction effect. The recommended travel area 3 is an area indicating a predetermined inter-vehicle distance behind the candidate preceding vehicle. The predetermined inter-vehicle distance is set in a range from a short inter-vehicle distance to a medium inter-vehicle distance set in the automatic following system such as the radar cruise control. In addition, the predetermined inter-vehicle distance changes according to the vehicle speed. In other words, the recommended travel area 3 changes according to the vehicle speed.

For example, a map indicating a relationship between the vehicle speed and the predetermined inter-vehicle distance (data of the predetermined inter-vehicle distance according to the vehicle speed) is stored in a storage unit of the control device 11. This map is set to have a relationship in which the inter-vehicle distance increases as the vehicle speed increases and the inter-vehicle distance decreases as the vehicle speed decreases. The travel area calculator 11c can calculate the recommended travel area 3 according to the vehicle speed using this map. Thus, the travel area calculator 11c can change the recommended travel area 3 according to the vehicle speed of the vehicle 1. Therefore, the travel area calculator 11c can set the recommended travel area 3 at a position where the reduction effect is large according to the energy consumption reduction effect and also at a position where it is possible to prevent the inter-vehicle distance to the preceding vehicle 2 from being shortened more than necessary. In other words, the travel area calculator 11c sets a display size and a display position of the recommended travel area 3.

The image generator 11d generates an image for displaying the recommended travel area 3. The image generator 11d generates an image of a travel area according to the recommended travel area 3 calculated by the travel area calculator 11c. Then, image data of the recommended travel area 3 generated by the image generator 11d is output to the display device 12.

The display device 12 displays a traveling position of the vehicle 1 relative to the preceding vehicle 2 in the platoon traveling. The display device 12 is a display that is disposed inside the vehicle 1 and displays an image at a position visually recognizable by a driver of the vehicle 1. For example, the display device 12 is configured with a car navigation device, a multi-information display, a head-up display, or the like. In other words, the display device 12 is configured with a human machine interface (HMI) mounted on the vehicle 1. Further, the display device 12 is controlled by the control device 11, and displays an image according to a signal input from the control device 11.

As illustrated in FIG. 1, the display device 12 displays a traveling position of the preceding vehicle 2 that will be the candidate preceding vehicle, the recommended travel area 3, and the traveling position of the vehicle 1. The recommended travel area 3 is displayed at a position behind the preceding vehicle 2 separated for a predetermined distance. This is to prevent the vehicle 1 from being too close to the preceding vehicle 2. Further, the positional relationship among the vehicle 1, the preceding vehicle 2, and the recommended travel area 3 is displayed in real time. When the vehicle 1 is traveling in the recommended travel area 3, an image indicating that the own vehicle is inside the recommended travel area 3 is displayed. By displaying the recommended travel area 3 relative to the preceding vehicle 2 based on the energy consumption reduction effect, and also displaying an image indicating the position of the own vehicle relative to the recommended travel area 3, it is possible for the driver to easily determine which position to travel. Note that FIG. 1 illustrates an image displayed on the display device 12 when the preceding vehicle 2 traveling ahead of the own vehicle exists while the vehicle 1 is traveling on a road having a plurality of lanes.

FIG. 3 is a flowchart illustrating a display control flow. Note that the control illustrated in FIG. 3 is repeatedly performed by the control device 11 while the vehicle 1 is traveling.

The control device 11 determines whether the candidate preceding vehicle is present (Step S101). In Step S101, it is determined whether there is the candidate preceding vehicle to follow by the own vehicle. In this case, the image of the front camera and the measurement result of the radar are acquired based on the preceding vehicle information input from the vehicle detection sensor 13 to the control device 11. Then, the candidate vehicle detector 11a analyzes the image of the front camera to determine whether the candidate preceding vehicle has been detected.

When there is no candidate preceding vehicle (Step S101: No), this control routine ends.

When the candidate preceding vehicle is present (Step S101: Yes), the control device 11 calculates the energy consumption reduction effect at the traveling position behind the candidate preceding vehicle (Step S102). In Step S102, the energy consumption reduction effect achievable or obtained by the vehicle 1 when the vehicle 1 follows the candidate preceding vehicle is calculated. A process in Step S102 is performed by the reduction effect calculator 11b.

Then, the control device 11 displays the recommended travel area 3 that can achieve the energy consumption reduction effect (Step S103) on the display device 12. Here, the control device 11 calculates the recommended travel area 3 according to the energy consumption reduction effect, and sets the display position and the display size of the recommended travel area 3. The display position is set at a position behind the candidate preceding vehicle in the display area of the display device 12. The display size is set to a predetermined value. Based on the set display position and display size, image generator 11d generates an image of recommended travel area 3. The image data is output from the control device 11 to the display device 12 and displayed on the display device 12. When a process in Step S103 is performed, this control routine ends.

The vehicle 1 configured as described above can acquire information on a relative position between the own vehicle and the preceding vehicle 2 by an autonomous sensor such as the millimeter wave radar. In addition, the energy consumption reduction effect is calculated with respect to the candidate preceding vehicle as a vehicle to follow in vehicles traveling around the own vehicle, and the recommended travel area 3 corresponding to the energy consumption reduction effect achievable by the own vehicle during the following travel is displayed on the display device 12. Here, the control device 11 sets the display position of the recommended travel area 3 at a position that secures the predetermined inter-vehicle distance behind the preceding vehicle 2, and sets the display size of the recommended travel area 3 according to the energy consumption reduction effect. Then, the control device 11 displays the recommended travel area 3 and the positional relationship between the own vehicle and the preceding vehicle 2 on the display device 12.

As described above, according to the first embodiment, it is possible to detect the candidate preceding vehicle as a vehicle to follow in the platoon traveling and display, on the display device 12, the recommended travel area 3 as the visual information based on the energy consumption reduction effect achievable by following the vehicle. As a result, it is possible to urge the driver to travel in the recommended travel area 3 to contribute to improving the fuel efficiency and electric efficiency.

In addition, since the recommended travel area 3 is set in the area indicating the predetermined inter-vehicle distance behind the preceding vehicle 2, it is possible to prevent the inter-vehicle distance to the preceding vehicle 2 from being shortened more than necessary. Furthermore, since the positional relationship among the recommended travel area 3, the own vehicle, and the preceding vehicle 2 is displayed on the display device 12, the driver of the vehicle 1 can visually recognize the positional relationship easily.

Note that the vehicle 1 is not limited to the battery electric vehicle, and may be a vehicle on which only an engine is mounted as the power source or a hybrid electric vehicle on which an engine and a motor are mounted as the power source. In other words, the reduction effect calculator 11b can calculate not only the power consumption reduction effect of the vehicle 1 but also a fuel consumption reduction effect of the vehicle 1. More specifically, the energy consumption described here includes at least one of power consumption and fuel consumption.

In addition, the vehicle 1 can be switched between a manual driving mode in which the vehicle travels by driver's manual operation and an automatic driving mode. Therefore, in the automatic driving mode, the electronic control device that controls travelling of the vehicle 1 may execute drive control for automatically adjusting the inter-vehicle distance by accelerating or decelerating the vehicle 1 so that the vehicle 1 is positioned inside the recommended travel area 3.

Still more, the configuration in which the vehicle detection sensor 13 includes both the front camera and the millimeter wave radar has been described. However, the present disclosure is not limited thereto. The vehicle detection sensor 13 may include only one of the front camera and the millimeter wave radar. For example, in a case where the vehicle detection sensor 13 includes only the front camera, the control device 11 can calculate the inter-vehicle distance between the own vehicle and the candidate preceding vehicle by analyzing a front image included in the preceding vehicle information. Alternatively, when the vehicle detection sensor 13 includes only the millimeter wave radar, the control device 11 can calculate the physical size of the candidate preceding vehicle based on the measurement result of the radar included in the preceding vehicle information.

Still more, the number of candidate preceding vehicles is not limited to one, and may be a plurality of vehicles. In other words, even when there are the plurality of candidate preceding vehicles detected by the candidate vehicle detector 11a, the reduction effect calculator 11b can calculate the energy consumption reduction effect for each of the candidate preceding vehicles, and the travel area calculator 11c can calculate the recommended travel area 3 for each of the candidate preceding vehicles according to the reduction effect.

Further, the control device 11 can execute highlighting control to highlight a position achieving a large energy consumption reduction effect in the recommended travel area 3 as compared with a position achieving a small energy consumption reduction effect. As highlighting, for example, a position where the energy consumption reduction effect is large is displayed in a darker color than other positions. As a result, it is possible to urge traveling at a position where the energy consumption reduction effect is large to further contribute to improving the fuel efficiency and electric efficiency.

The map indicating the relationship between the vehicle speed and the predetermined inter-vehicle distance is not limited to the vehicle speed of the own vehicle, and may be a map corresponding to a relative vehicle speed between the own vehicle and the preceding vehicle 2. In this map, the inter-vehicle distance is set to be long when the vehicle speed of the own vehicle is higher than the vehicle speed of the preceding vehicle 2 as the relative vehicle speed, and the inter-vehicle distance is set to be short when the vehicle speed of the own vehicle is lower than the vehicle speed of the preceding vehicle 2 as the relative vehicle speed. As a result, the inter-vehicle distance to the preceding vehicle 2 in the following travel can be appropriately set.

Further, the example of displaying the recommended travel area 3, the traveling position of the vehicle 1, and the traveling position of the preceding vehicle 2 on the display device 12 has been described, but the present disclosure is not limited thereto. Since the recommended travel area 3 is the area indicating the predetermined inter-vehicle distance behind the candidate preceding vehicle, it means that the inter-vehicle distance to the preceding vehicle 2 is already secured. Therefore, it is sufficient to visualize the positional relationship between the recommended travel area 3 and the own vehicle on the display device 12, and the traveling position of the preceding vehicle 2 is not necessarily displayed. In other words, the control device 11 can execute the display control of displaying the traveling position of the vehicle 1 and the recommended travel area 3 on the display device 12. Note that, in order for the driver to easily determine whether the vehicle 1 is traveling in the recommended travel area 3, it is essential to display the positional relationship between the traveling position of the own vehicle and the recommended travel area 3.

### Second Embodiment

Next, a second embodiment will be described. In the second embodiment, the recommended travel area 3 is displayed on a display of a mobile terminal owned by an occupant of the vehicle. In the description of the second embodiment, components same as those of the first embodiment will not be described, and the same reference signs thereof will be given.

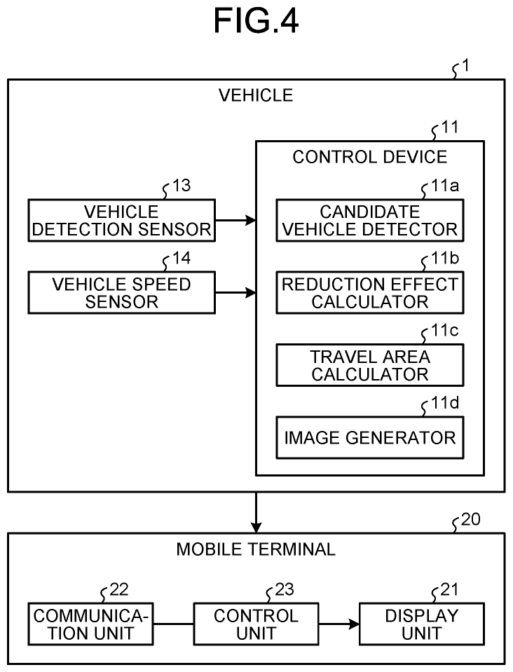

FIG. 4 is a block diagram illustrating a configuration of the second embodiment. In the second embodiment, an image of the recommended travel area 3 generated by the control device 11 of the vehicle 1 is displayed on a display unit 21 of a mobile terminal 20. In other words, the display unit 21 on a mobile terminal side functions as a display device. The vehicle 1 and the mobile terminal 20 are communicably connected.

The vehicle 1 includes the control device 11, the vehicle detection sensor 13, and the vehicle speed sensor 14. The control device 11 is configured to include a communication unit that transmits and receives information to and from the mobile terminal 20. The communication unit transmits image data of the recommended travel area 3 generated by the image generator 11d to the mobile terminal 20.

The mobile terminal 20 is configured with a mobile terminal such as a smartphone carried by the occupant of the vehicle 1. The mobile terminal 20 includes the display unit 21, a communication unit 22, and a control unit 23.

The display unit 21 is a display of the mobile terminal 20. The display unit 21 displays the image data of the recommended travel area 3 input from the vehicle 1.

The communication unit 22 communicates with the vehicle 1 and receives the image data of the recommended travel area 3 transmitted from the vehicle 1. The mobile terminal 20 may transmit and receive information in a state of being connected to the vehicle 1 by wire, or may transmit and receive information by wireless communication in a state of being connected wirelessly. Furthermore, a method of wireless communication is not particularly limited to short-distance communication or long-distance communication.

The control unit 23 is a controller that controls the display unit 21, and causes the display unit 21 to display the image data of the recommended travel area 3 acquired by the communication unit 22. The control unit 23 is configured with a microcomputer including a CPU, a RAM, a ROM, and an input/output interface. In the second embodiment, the control device of the display device includes the control unit 23.

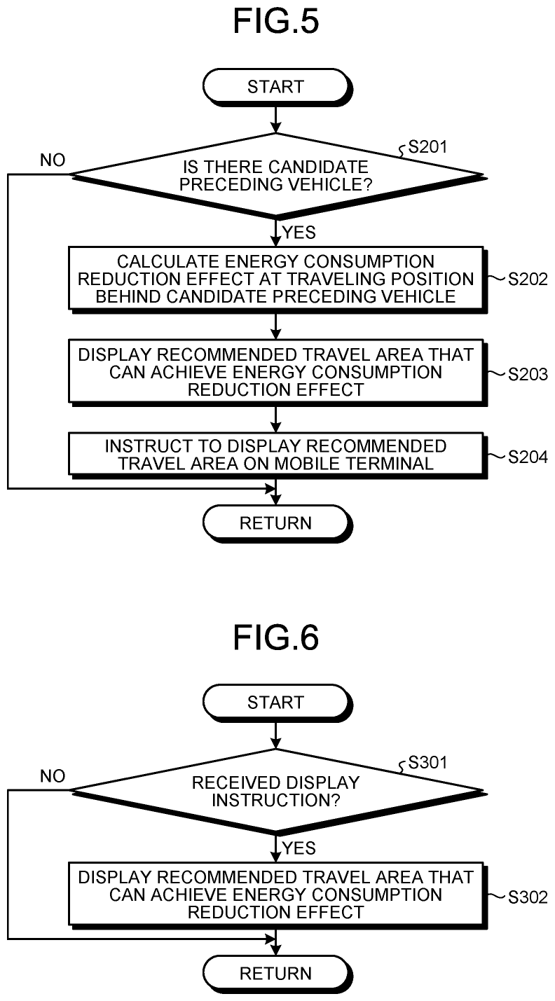

In the vehicle 1 and the mobile terminal 20 of the second embodiment configured as described above, the display control is executed in a state where the display unit 21 of the mobile terminal 20 is disposed at a position visually recognizable by the driver of the vehicle 1 while the vehicle 1 is traveling. FIGS. 5 and 6 illustrate a flow of this control.

FIG. 5 is a flowchart illustrating a control flow on the vehicle side according to the second embodiment. Note that Steps S201 to S203 illustrated in FIG. 5 are similar to Steps S101 to S103 illustrated in FIG. 3, and thus description thereof is omitted. In addition, the control illustrated in FIG. 5 is repeatedly performed by the control device 11 while the vehicle 1 is traveling.

When a process in Step S203 is performed, the control device 11 outputs a display instruction to cause the mobile terminal 20 to display the image data of the recommended travel area 3 (Step S204). In Step S204, the image data of the recommended travel area 3 is transmitted to the mobile terminal 20 brought into a cabin of the vehicle 1. For example, the control device 11 transmits the image data of the recommended travel area 3 to the mobile terminal 20 in a state that a camera of the mobile terminal 20 is capturing ahead of the vehicle 1. When a process in Step S204 is performed, this control routine ends.

FIG. 6 is a flowchart illustrating a control flow on the mobile terminal side according to the second embodiment. The control illustrated in FIG. 6 is repeatedly performed by the control unit 23.

The mobile terminal 20 determines whether the display instruction from the vehicle 1 has been received (Step S301). In Step S301, it is determined whether the image data of the recommended travel area 3 transmitted from the vehicle 1 has been received.

When the display instruction from the vehicle 1 is not received (Step S301: No), this control routine ends.

When the display instruction from the vehicle 1 has been received (Step S301: Yes), the control unit 23 causes the display unit 21 to display the recommended travel area 3 that can achieve the energy consumption reduction effect (Step S302). In Step S302, the display unit 21 displays the image data of the recommended travel area 3 received from the vehicle 1. When a process in Step S302 is performed, this control routine ends.

According to the second embodiment, the recommended travel area 3 can be displayed on the display unit 21 of the mobile terminal 20 brought into the cabin of the vehicle 1. Further, since the display device is not limited to an in-vehicle device, an application range of the display device is widened.

### Third Embodiment

Next, a third embodiment will be described. In the third embodiment, all the functions for displaying the recommended travel area 3 included in the vehicle 1 in the first embodiment are provided to a mobile terminal brought into a cabin of the vehicle 1. In the description of the third embodiment, components same as those of the first embodiment and the second embodiment will not be described, and the same reference signs thereof will be given.

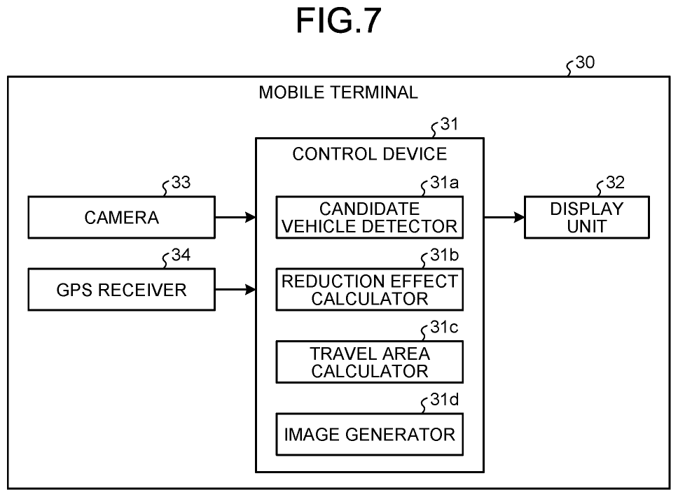

FIG. 7 is a block diagram illustrating a configuration of the third embodiment. In the third embodiment, a mobile terminal 30 brought into the cabin of the vehicle 1 detects the preceding vehicle 2 and displays the recommended travel area 3. The mobile terminal 30 includes a control device 31, a display unit 32, a camera 33, and a GPS receiver 34.

The control device 31 includes an electronic control device, and has a hardware configuration similar to that of the control device 11 according to the first embodiment. The control device 31 sets the vehicle 1 into which the mobile terminal 30 is brought as a predetermined vehicle, and executes the display control to display, on the display unit 32, information on the preceding vehicle 2 traveling ahead of the predetermined vehicle.

In addition, signals from various sensors provided in the mobile terminal 30 are input to the control device 31. For example, signals from the camera 33 and the GPS receiver 34 are input to the control device 31.

The camera 33 is a camera mounted on the mobile terminal 30, and functions as a sensor for detecting the preceding vehicle 2 traveling ahead of the vehicle 1 in a state that the mobile terminal 30 is brought into the vehicle 1. The mobile terminal 30 is disposed at a position and in a direction such that the camera 33 captures ahead of the vehicle 1 from inside the vehicle 1. In addition, the camera 33 outputs, to the control device 31, the preceding vehicle information including the image as the front camera.

The GPS receiver 34 receives a signal from a GPS satellite, and functions as a vehicle speed sensor that detects a vehicle speed of the vehicle 1 in the state that the mobile terminal 30 is brought into the vehicle 1. The position information acquired by the GPS receiver 34 is output to the control device 31. Since the mobile terminal 30 can acquire its own position information by the GPS receiver 34, the control device 31 can calculate its traveling speed, i.e., a speed of the vehicle 1, based on the position information.

Then, for the predetermined vehicle into which the mobile terminal 30 is brought, the control device 31 executes the display control to display the recommended travel area 3 relative to the preceding vehicle 2 traveling ahead of the vehicle 1 based on signals input from the camera 33 and the GPS receiver 34. In this case, the image data of the recommended travel area 3 is output from the control device 31 to the display unit 32.

More specifically, the control device 31 includes a candidate vehicle detector 31a, a reduction effect calculator 31b, a travel area calculator 31c, and an image generator 31d. The candidate vehicle detector 31a, the reduction effect calculator 31b, the travel area calculator 31c, and the image generator 31d are functionally similar to the candidate vehicle detector 11a, the reduction effect calculator 11b, the travel area calculator 11c, and the image generator 11d in the first embodiment.

The candidate vehicle detector 31a detects the preceding vehicle 2 traveling ahead of the predetermined vehicle by analyzing the image ahead of the predetermined vehicle input from the camera 33.

The reduction effect calculator 31b calculates a physical size and an inter-vehicle distance to the candidate preceding vehicle based on the preceding vehicle information acquired from the camera 33, and also calculates the vehicle speed based on the position information acquired from the GPS receiver 34. Then, the reduction effect calculator 31b calculates an energy consumption reduction effect.

The travel area calculator 31c calculates the recommended travel area 3 based on the energy consumption reduction effect calculated by the reduction effect calculator 31b.

The image generator 31d generates the image data on the recommended travel area 3 calculated by the travel area calculator 31c. The image data of the recommended travel area 3 generated by the image generator 31d is output to the display unit 32.

The display unit 32 is a display of the mobile terminal 20. The display unit 32 displays an image of the recommended travel area 3 generated by the image generator 31d.

According to the third embodiment, it is possible to display the recommended travel area 3 regarding the traveling position behind the preceding vehicle traveling ahead of the vehicle 1 by using the mobile terminal 30 brought into the cabin of the vehicle 1.

According to the present disclosure, it is possible to visually notify the driver of the predetermined vehicle of the recommended travel area that can reduce energy consumption of the predetermined vehicle in the platoon traveling. Therefore, the driver can be urged to travel in the recommended travel area that can contribute to improvement of fuel efficiency and electric efficiency. In addition, since the recommended travel area is an area indicating a predetermined inter-vehicle distance to a candidate preceding vehicle, it is possible to suppress approaching the candidate preceding vehicle more than necessary.

According to an embodiment, it is possible to visually notify the driver of the predetermined vehicle of the recommended travel area that can reduce energy consumption of the predetermined vehicle in the platoon traveling. Therefore, the driver can be urged to travel in the recommended travel area that can contribute to improvement of fuel efficiency and electric efficiency. In addition, since the recommended travel area is an area indicating a predetermined inter-vehicle distance to a candidate preceding vehicle, it is possible to suppress approaching the candidate preceding vehicle more than necessary.

According to an embodiment, it is possible to encourage traveling at a position with a greater energy consumption reduction effect. Accordingly, it is possible to further contribute to improvement of fuel efficiency and electric efficiency.

According to an embodiment, since a positional relationship among the recommended travel area, the predetermined vehicle, and the candidate preceding vehicle is visualized, the driver can easily understand a relative positional relationship.

According to an embodiment, it is possible to visually notify the driver of the predetermined vehicle of the recommended travel area that can reduce energy consumption of the predetermined vehicle in the platoon traveling. Therefore, the driver can be urged to travel in the recommended travel area that can contribute to improvement of fuel efficiency and electric efficiency. In addition, since the recommended travel area is an area indicating a predetermined inter-vehicle distance to a candidate preceding vehicle, it is possible to suppress approaching the candidate preceding vehicle more than necessary.

According to an embodiment, it is possible to encourage traveling at a position with a greater energy consumption reduction effect. Accordingly, it is possible to further contribute to improvement of fuel efficiency and electric efficiency.

According to an embodiment, since a positional relationship among the recommended travel area, the predetermined vehicle, and the candidate preceding vehicle is visualized, the driver can easily understand a relative positional relationship.

According to an embodiment, the recommended travel area is displayed on a display device so that the driver can be informed of an area that can reduce energy consumption in the platoon traveling.

According to an embodiment, a display unit of a mobile terminal displays the recommended travel area so that the driver can be informed of the area that can reduce energy consumption in the platoon traveling.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control device of a display device that displays a traveling position of a predetermined vehicle relative to a preceding vehicle in platoon traveling, the control device comprising:
a detector that detects a candidate preceding vehicle to follow from among one or more vehicles traveling around the predetermined vehicle;
a calculator that calculates, with respect to the detected candidate preceding vehicle, a reduction effect of energy consumption obtained by the predetermined vehicle when the predetermined vehicle travels following the candidate preceding vehicle; and
a controller that executes display control to display, on the display device, a recommended travel area based on the reduction effect of energy consumption as an area in which the predetermined vehicle is recommended to travel,
wherein
the recommended travel area is an area indicating a predetermined inter-vehicle distance behind the candidate preceding vehicle.

2. The control device according to claim 1, wherein
the controller executes highlighting control to highlight more in a position where the reduction effect is greater than in a position where the reduction effect is less in the recommended travel area.

3. The control device according to claim 1, wherein
the controller executes the display control to display, on the display device, the traveling position of the predetermined vehicle, the recommended travel area, and a traveling position of the candidate preceding vehicle.

4. A vehicle equipped with the control device according to claim 1, wherein
the control device executes the display control to display, on the display device, the recommended travel area based on the reduction effect of energy consumption obtained by an own vehicle when the own vehicle travels following the candidate preceding vehicle.

5. A mobile terminal communicably connected to the vehicle according to claim 4, the mobile terminal comprising:
a communication unit that receives image data of the recommended travel area transmitted from the vehicle; and
a display unit that displays the image data of the recommended travel area received by the communication unit.

6. A display device that displays a traveling position of a predetermined vehicle relative to a preceding vehicle in platoon traveling, the display device displaying a recommended travel area based on a reduction effect of energy consumption obtained by the predetermined vehicle when the predetermined vehicle travels following a candidate preceding vehicle detected as a vehicle to follow from among one or more vehicles traveling around the predetermined vehicle, wherein
the recommended travel area is an area where the predetermined vehicle is recommended to travel and that indicates a predetermined inter-vehicle distance behind the candidate preceding vehicle.

7. The display device according to claim 6, wherein
in the recommended travel area, a position where the reduction effect is greater is more highlighted than a position where the reduction effect is less.

8. The display device according to claim 6, wherein
when the recommended travel area is displayed, the traveling position of the predetermined vehicle and a traveling position of the candidate preceding vehicle are displayed together with the recommended travel area.
